(19) United States
(12) Patent Application Publication
(10) Pub. No.: US 2024/0140018 A1
(43) Pub. Date: May 2, 2024

(54) APPARATUS FOR ATTACHING PROTECTIVE FILM TO ATTACHMENT TARGET

(71) Applicant: TCI CO., LTD., Ulsan (KR)

(72) Inventor: Yunyoung Kim, Ulsan (KR)

(21) Appl. No.: 18/496,818

(22) Filed: Oct. 27, 2023

(30) Foreign Application Priority Data
Oct. 31, 2022 (KR) 10-2022-0142267

(51) Int. Cl. B29C 63/00; B29C 63/02

(52) U.S. Cl. CPC B29C 63/0004; B29C 63/0065; B29C 63/02; B29C 2063/028

(57) ABSTRACT

An apparatus for attaching a protective film to a film attachment target includes a protective film guide around which a protective film is wound in a roll form; a protective film unwinding roller configured to unwind the protective film from the protective film guide; a vacuum suction guide configured to vacuum-suction one end of the unwound protective film, and to transfer the vacuum-suctioned one end of the protective film to a corresponding end of an area of the film attachment target; a pressing means configured to: press and attach the vacuum-suctioned end of the protective film to the corresponding end of the area of the film attachment target; and then press and attach the protective film to a remaining area of the film attachment target while moving and pressing an area of the protective film overlapping the remaining area; and a cutter for cutting the protective film.

### CROSS-REFERENCE TO RELATED APPLICATION

This application claims priority from Korean Patent Application No. 10-2022-0142267 filed on Oct. 31, 2022 in the Korean Intellectual Property Office, and all the benefits accruing therefrom under 35 U.S.C. 119, the contents of which in its entirety are herein incorporated by reference.

### BACKGROUND

### Field

The present disclosure relates to an apparatus for attaching a protective film to an film attachment target, and more particularly, to an apparatus for attaching a protective film to an film attachment target to prevent contamination thereof from an outside, and scratches thereon.

### Description of Related Art

A protective film market for protecting a painted surface in the automobile and transportation sectors is continuously and significantly growing. This protective film field is a field whose growth is accelerating as awareness of vehicle maintenance increases.

The automobile is an assembly of a plurality of parts. The parts are manufactured in different factories, and are transported and assembled with each other by a final manufacturer.

During the transportation process of each part after the manufacturing of each part there is a possibility that the part may be damaged due to external impacts. For example, there is a problem that the exterior may be damaged due to impact between the parts. Moreover, as buyers increasingly place importance on external aesthetics, the parts may be returned due to a small scratch thereon, or a car which has been finally assembled may be refused by the buyer.

Therefore, it is common to transport these parts with a protective film attached thereto during the transport process.

However, even when the protective film is attached thereto, when bubbles are generated on the surface to which the protective film is attached, a problem occurs in which only the bubble area is discolored by ultraviolet rays.

Therefore, in the field of the automotive exterior parts that emphasizes external aesthetics, there is a need to not only prevent the external damage, but also prevent the discoloring due to air bubbles using the protective film during transportation.

A prior art literature to the present disclosure includes following patent literatures:

Korean Patent No. 10-2179253 (registered on Nov. 10, 2020)

Korean Patent No. 10-1480684 (registered on Jan. 5, 2015) Korean Patent No. 10-1724028 (registered on Mar. 31, 2017)

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is intended to solve the problems of the prior art as described above. A purpose of the present disclosure is to provide an apparatus for attaching the protective film to the surface of the film attachment target which can suppress the generation of the air bubbles in the process of attaching the protective film to the surface of the film attachment target.

Purposes in accordance with the present disclosure are not limited to the above-mentioned purpose. Other purposes and advantages in accordance with the present disclosure as not mentioned above may be understood from following descriptions and more clearly understood from embodiments in accordance with the present disclosure. Further, it will be readily appreciated that the purposes and advantages in accordance with the present disclosure may be realized by features and combinations thereof as disclosed in the claims.

One aspect of the present disclosure provides an apparatus for attaching a protective film to a film attachment target, the apparatus comprising: a protective film guide around which a protective film is wound in a roll form; a protective film unwinding roller configured to unwind the protective film from the protective film guide; a vacuum suction guide configured to vacuum-suction one end of the unwound protective film, and to transfer the vacuum-suctioned one end of the protective film to a corresponding end of an area of the film attachment target; a pressing means configured to: press and attach the vacuum-suctioned one end of the protective film to the corresponding end of the area of the film attachment target; and then press and attach the protective film to a remaining area of the film attachment target while moving along and on and pressing an area of the protective film overlapping the remaining area of the film attachment target; and a cutter for cutting the protective film.

In one implementation, the pressing means has pressed and attached the vacuum-suctioned one end of the protective film to the corresponding end of the area of the film attachment target, the vacuum suction guide is configured to deactivate a vacuum state thereof such that the protective film is removed therefrom.

In one implementation, the vacuum suction guide includes a suction-deactivating air spray hole for spraying suction-deactivating air into an inside of the vacuum suction guide and toward the protective film so as to prevent lift-off of the protective film from the film attachment target.

In one implementation, the vacuum suction guide further includes a heating element for heating the suction-deactivating air to improve an adhesion between the film and the film attachment target.

In one implementation, the pressing means includes a plurality of mini pressing bars controlled to move vertically to different vertical levels based on a shape and a curved surface of the film attachment target, wherein the plurality of mini pressing bars are controlled to press the protective film toward the target under a uniform pressure.

In one implementation, the pressing means further includes a pressure sensor disposed on top of the plurality of mini pressing bars and configured to measure each pressure applied from each of the plurality of mini pressing bars to the film.

In one implementation, the cutter includes a pressurized air spray hole for spraying pressurized air toward the protective film facing the film attachment target so as to prevent lift-off of the protective film from the film attachment target.

In one implementation, the cutter further includes a heating element for heating the pressurized air to improve an adhesion between the film and the film attachment target.

According to the present disclosure, in the process of attaching the protective film to the film attachment target, the air bubbles generated due to the lifting phenomenon of the protective film can be suppressed, thereby preventing contamination and scratches and preventing the color change caused by the air bubbles in the process of transporting and supplying the film attachment target to a destination.

In addition to the effects as described above, specific effects in accordance with the present disclosure will be described together with following detailed descriptions for carrying out the disclosure.

### BRIEF DESCRIPTION OF DRAWINGS

FIG. 1 is a conceptual diagram of an apparatus for attaching a protective film to an film attachment target according to the present disclosure.

FIG. 2 is a cross-sectional view of a vacuum suction guide according to the present disclosure.

FIG. 3 is an example diagram of a pressing means according to the present disclosure.

### DETAILED DESCRIPTION

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may include within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entirety of list of elements and may not modify the individual elements of the list. When referring to “C to D”, this means C inclusive to D inclusive unless otherwise specified.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between and connected to the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like may be disposed “on” or “on a top” of another layer, film, region, plate, or the like, the former may directly contact the latter or still another layer, film, region, plate, or the like may be disposed between and connected to the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between and connected to the former and the latter. Further, as used herein, when a layer, film, region, plate, or the like may be disposed “below” or “under” another layer, film, region, plate, or the like, the former may directly contact the latter or still another layer, film, region, plate, or the like may be disposed between and connected to the former and the latter. As used herein, when a layer, film, region, plate, or the like is directly disposed “below” or “under” another layer, film, region, plate, or the like, the former directly contacts the latter and still another layer, film, region, plate, or the like is not disposed between and connected to the former and the latter.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one example, when a certain embodiment may be implemented differently, a function or operation specified in a specific block may occur in a sequence different from that specified in a flowchart. For example, two consecutive blocks may be actually executed at the same time. Depending on a related function or operation, the blocks may be executed in a reverse sequence.

The features of the various embodiments of the present disclosure may be partially or entirely combined with each other, and may be technically associated with each other or operate with each other. The embodiments may be implemented independently of each other and may be implemented together in an association relationship.

Spatially relative terms, such as “beneath,” “below,” “lower,” “under,” “above,” “upper,” and the like, may be used herein for ease of explanation for illustrating one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented, for example, rotated 90 degrees or at other orientations, and the spatially relative descriptors used herein should be interpreted accordingly.

Hereinafter, preferred embodiments of the present disclosure will be described with reference to the attached drawings.

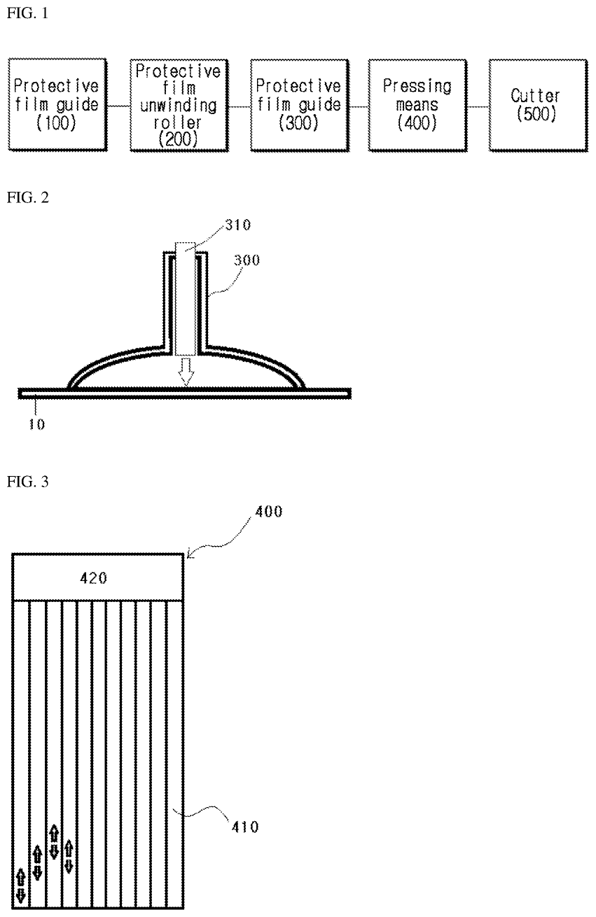

FIG. 1 is a conceptual diagram of an apparatus for attaching a protective film to an film attachment target according to the present disclosure.

Referring to FIG. 1, the apparatus for attaching the protective film to the film attachment target according to the present disclosure includes a protective film guide 100 around which a protective film in a roll form is wound, a protective film unwinding roller 200 for unwinding the protective film from the protective film guide 100, a vacuum suction guide 300 that vacuum-suctions one end of the protective film unwound by the protective film unwinding roller 200 and moves one end of the protective film to a corresponding end of the film attachment target, a pressing means 400 which presses and adheres the protective film to the film attachment target and moves along the film attachment target to attach the protective film thereto, and a cutter 500 that cuts the protective film after the pressing means 400 has passed by the film attachment target.

The protective film guide 100 is a guide around which the protective film in a roll form is wound. The protective film guide 100 may be interpreted as a holder, and may be a guide that holds not only the roll type protective film, but also a Z-shaped folded protective film.

The protective film unwinding roller 200 unwinds the protective film from the protective film guide 100. In other words, the protective film unwinding roller 200 is a roller for unwinding the protective film.

FIG. 2 is a cross-sectional view of the vacuum suction guide according to the present disclosure. In this regard, an arrow in FIG. 2 refers to a direction in which air is sprayed.

Referring to FIG. 2, the vacuum suction guide 300 contacts and vacuum-suctions one end of the protective film unwound from the protective film guide 100 by the protective film unwinding roller 200. Furthermore, the vacuum suction guide 300 moves the vacuum-suctioned end of the protective film to a corresponding end of the film attachment target. Therefore, the protective film has been moved such that the protective film may cover an entire area of the film attachment target.

At the same time as a time point at which the pressing means 400 which will be described later presses and attach one end of the protective film to the film attachment target or after the pressing means 400 which will be described later presses and attach one end of the protective film to the film attachment target, a vacuum state of the vacuum suction guide 300 is deactivated. Therefore, when the pressing means 400 has pressed and attached one end of the protective film to the film attachment target, the vacuum suction guide 300 is removed from the protective film.

In this regard, the vacuum suction guide 300 includes a suction-deactivating air spray hole 310 that sprays the air into an inside of the suctioning guide to deactivate the suction ability.

The suction-deactivating air spray hole 310 sprays the air from the inside of the suctioning guide onto the suctioned surface of the protective film 10 to deactivate the suctioning state of the vacuum suction guide 300 suctioning the film 10 in a vacuum state.

The purpose of the suction-deactivating air spray hole 310 is not to simply deactivate the vacuum state, but to prevent the protective film from being lifted off from the film attachment target by the vacuum suction guide 300 during the process of deactivating the vacuum state. In other words, the suction-deactivating air spray hole 310 of the vacuum suction guide 300 may spray the air toward the surface of the film to prevent the protective film from lifting off from the film attachment target. Tus, the bubbles generation between the protective film and the film attachment target can be suppressed.

Furthermore, the suction-deactivating air spray hole 310 may include a heating element that heats the air being sprayed. An appropriate attachment temperature of each of the protective films to be attached to the film attachment target is defined based on a type of an adhesive component of the film. Thus, the heating means may heat an area where the vacuum suction guide 300 is in contact with the protective film to the appropriate temperature, thereby improving the adhesion of the protective film to the film attachment target.

The pressing means 400 presses one end of the protective film as vacuum-suctioned by the vacuum suction guide 300 toward the film attachment target.

Thus, the pressing means 400 presses one end of the protective film toward the film attachment target and attaches one end of the protective film to a corresponding end of the surface of the film attachment target.

In this regard, during the process of attaching the protective film to the film attachment target using the pressing means 400, the surface of the film attachment target may be damaged by the pressure of the pressing means 400. Accordingly, the pressing means 400 includes a pressure sensor 420 that measures the pressure applied to the pressing means 400. Therefore, based on the pressure measurement by the sensor 420, the pressure the pressing means 400 may press the film toward the film attachment target within a predefined pressure range such that the target is not damaged. In this regard, the predefined pressure range may be determined based on the type of the target.

FIG. 3 is an example of the pressing means according to the present disclosure.

Referring to FIG. 3, the pressing means 400 includes a plurality of mini pressing bars 410 that move up and down so as to apply a uniform pressure to a top surface and a curved surface of the film attachment target to which the protective film is to be attached.

The plurality of mini pressing bars 410 may move vertically to different vertical levels based on the shape of the film attachment target. This is because the film attachment target may have a 3-dimensional shape. Thus, the plurality of mini pressing bars 410 may adhere the protective film to the film attachment target at up to the maximum pressure that the film attachment target can endure, without being limited by the shape and the curved surface of the film attachment target. Therefore, the plurality of mini pressing bars 410 may move vertically to different vertical levels based on the shape of the film attachment target, while pressing the protective film toward the target under the same pressure.

When the pressing means 400 has pressed and attached one end of the film to one end of the surface of the film attachment target, the pressing means 400 may move along the surface of the film attachment target toward a non-pressed area and then may press and attach the non-pressed area of the protective film to the entire surface of the film attachment target.

When the plurality of mini pressing bars 410 move along the surface of the film attachment target, the pressure sensor 420 may measure the pressures from the plurality of mini pressing bars 410 respectively to the film. Thus, a controller (not shown) may control the pressures from the plurality of mini pressing bars 410 respectively to the film to be uniform while the plurality of mini pressing bars 410 move along the surface of the film attachment target.

When the pressing means 400 has attached the film onto an entirety of a target area of the surface of the film attachment target while the pressing means 400 moves along the surface of the film attachment target, the cutter 500 may cut the protective film in an area that does not overlap the surface of the film attachment target.

In this regard, the cutter 500 includes a pressurized air spray hole 510 that sprays the pressurized air toward the film attachment target.

When the protective film is cut in a straight manner while being attached to the film attachment target or is cut along an outer circumference of the film attachment target, the protective pad may shake due to variation in the pressure applied to the protective film, and the protective film may lift off on the edge area of the film attachment target.

However, when the pressurized air spray hole 510 sprays the pressurized air toward the film attachment target while the cutter 500 may cut the protective film, the protective pad may be prevented from shaking due to variation in the pressure applied to the protective film, and the protective film may be prevented from lifting off on the edge area of the film attachment target.

Furthermore, the pressurized air spray hole 510 may include a heating element that heats the air being sprayed. An appropriate attachment temperature of each of the protective films to be attached to the film attachment target is defined based on a type of an adhesive component of the film. Thus, the heating means may heat an area where the cutter faces the protective film to the appropriate temperature, thereby improving the adhesion of the protective film to the film attachment target, and preventing the bubbles from being generated, which may otherwise may be generated due to the lift off of the protective film during the cutting process using the cutter 500.

Although the embodiments of the present disclosure have been described above with reference to the accompanying drawings, the present disclosure may not be limited to the embodiments and may be implemented in various different forms. Those of ordinary skill in the technical field to which the present disclosure belongs will be able to understand that the present disclosure may be implemented in other specific forms without changing the technical idea or essential features of the present disclosure. Therefore, it should be understood that the embodiments as described above are not restrictive but illustrative in all respects.

What is claimed is:

1. An apparatus for attaching a protective film to a film attachment target, the apparatus comprising:
a protective film guide around which a protective film is wound in a roll form;
a protective film unwinding roller configured to unwind the protective film from the protective film guide;
a vacuum suction guide configured to vacuum-suction one end of the unwound protective film, and to transfer the vacuum-suctioned one end of the protective film to a corresponding end of an area of the film attachment target;
a pressing means configured to:
press and attach the vacuum-suctioned one end of the protective film to the corresponding end of the area of the film attachment target; and
then press and attach the protective film to a remaining area of the film attachment target while moving along and on and pressing an area of the protective film overlapping the remaining area of the film attachment target; and
a cutter for cutting the protective film.

2. The apparatus of claim 1, wherein when the pressing means has pressed and attached the vacuum-suctioned one end of the protective film to the corresponding end of the area of the film attachment target, the vacuum suction guide is configured to deactivate a vacuum state thereof such that the protective film is removed therefrom.

3. The apparatus of claim 2, wherein the vacuum suction guide includes a suction-deactivating air spray hole for spraying suction-deactivating air into an inside of the vacuum suction guide and toward the protective film so as to prevent lift-off of the protective film from the film attachment target.

4. The apparatus of claim 3, wherein the vacuum suction guide further includes a heating element for heating the suction-deactivating air to improve adhesion between the film and the film attachment target.

5. The apparatus of claim 4, wherein the pressing means includes a plurality of mini pressing bars controlled to move vertically to different vertical levels based on a shape and a curved surface of the film attachment target,
wherein the plurality of mini pressing bars are controlled to press the protective film toward the target under a uniform pressure.

6. The apparatus of claim 5, wherein the pressing means further includes a pressure sensor disposed on top of the plurality of mini pressing bars and configured to measure each pressure applied from each of the plurality of mini pressing bars to the film.

7. The apparatus of claim 6, wherein the cutter includes a pressurized air spray hole for spraying pressurized air toward the protective film facing the film attachment target so as to prevent lift-off of the protective film from the film attachment target.

8. The apparatus of claim 7, wherein the cutter further includes a heating element for heating the pressurized air to improve adhesion between the film and the film attachment target.
